(19) United States
(12) Patent Application Publication
(10) Pub. No.: US 2008/0266785 A1
(43) Pub. Date: Oct. 30, 2008

(54) HEAT DISSIPATOR FASTENER KIT

(75) Inventors: Yun-Yu YEH, Zhonghe City (TW); Chia-Ming TUNG, Sansia Chen (TW); Chien-Kai LIN, Banciao City (TW)

Correspondence Address: PATENTTM.US, P. O. BOX 82788, PORTLAND, OR, 97282-0788, US

(73) Assignee: XIGMATEK CO., LTD., Zhonghe City (TW)

(21) Appl. No.: 11/690,017

(22) Filed: Mar. 22, 2007

(51) Int. Cl. G06F 1/20

(52) U.S. Cl. 361/687

(57) ABSTRACT

A heat dissipator fastening kit includes two retaining bars, at least one and as many as three different brackets and multiple fasteners. The retaining bars are resilient, attach to opposite sides of an appropriate heat dissipator and respectively have two ends. The bracket attaches to a motherboard around a CPU and to the retaining bars and has several embodiments to accommodate different types of CPUs, e.g. AM2, K8, LGA775 or P4, and their motherboards. The fasteners attach the retaining bars to a heat dissipator and the bracket and the bracket to a motherboard. With such an arrangement, the heat dissipator fastening kit will be convenient and easy to use.

### BACKGROUND OF THE INVENTION

1. Field of the Invention

The present invention relates to a fastener, and more particularly to a heat dissipator fastener kit that is convenient and easy to use.

2. Description of Related Art

Computers comprise a motherboard and a central processing unit (CPU). The motherboards are mounted respectively in the computers. The CPUs are mounted respectively on the motherboards.

However, advanced, high-power CPUs generate a tremendous amount of heat that may reduce the CPU's efficiency or damage the CPU or other electronic components inside the computer. Therefore, heat dissipators with greater heat dissipating efficiency have been developed.

The heat dissipator is mounted securely directly on a CPU with a fastener that connects the heat dissipator to the motherboard. However, the proliferation of smaller and special purpose computers has resulted in the development of different types of motherboards suited for specific CPUs. Each type of motherboard has different slots and circuit layout, so unique fasteners have tended to be designed for each type of motherboard. When motherboards or CPUs are upgraded or DIY (“do it yourself”) computers are purchased, consumers usually have to buy a suitable heat sink or heat dissipator fastener, which results in having to select a specific fastener compatible with the specific motherboard and CPU. Selecting an inappropriate fastener will result in not being able to attach the heat dissipator correctly to the motherboard or CPU. This makes upgrading computers and procuring parts for DIY computers considerably less than “user-friendly.”

To overcome the shortcomings, the present invention provides a heat dissipator fastener kit to obviate or mitigate the aforementioned problems.

### SUMMARY OF THE INVENTION

The main objective of the present invention is to provide a heat dissipator fastener kit that can be used with many types of motherboards to fasten a heat dissipator securely and efficiently to a CPU mounted on the motherboard.

To achieve the objective, the heat dissipator fastener kit comprises at least one bracket and as many as three different brackets and multiple fasteners and spacers. The bracket attaches to a motherboard around a CPU and has several embodiments to accommodate different types of CPUs, e.g. AM2, K8, LGA775 or P4, and their motherboards. The fasteners attach the retaining bars to a heat dissipator and the bracket and the bracket to a motherboard. The spacers are cylindrical and hollow and are mounted respectively around motherboard fasteners between the bracket and the motherboard to provide adequate separation between the bracket and the corresponding motherboard.

With such an arrangement, the heat dissipator fastener kit will be convenient and easy to use.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a heat dissipator fastener kit in accordance with the present invention;

FIG. 2 is an exploded perspective view of a one-piece bracket of a heat dissipator fastener in accordance with the present invention;

FIG. 3 is an operational side view in partial section of a heat dissipator fastener with the one-piece bracket in FIG. 2 mounted on a motherboard and holding a heat dissipator against an AM2 CPU;

FIG. 4 is an operational side view in partial section of a heat dissipator fastener with the one piece bracket in FIG. 2 mounted on a motherboard and holding a heat dissipator against a K8 CPU;

FIG. 5 is an exploded perspective view of a first embodiment of a two-piece first bracket of a heat dissipator fastener in accordance with the present invention;

FIG. 6 is an operational side view in partial section of a heat dissipator fastener with the two-piece first bracket in FIG. 5 mounted on a motherboard and holding a heat dissipator against an LGA775 CPU;

FIG. 7 is a perspective view of a second embodiment of a two-piece second bracket of a heat dissipator fastener in accordance with the present invention; and

FIG. 8 is an operational side view in partial section of a heat dissipator fastener with the two-piece second bracket in FIG. 7 mounted on a motherboard and holding a heat dissipator against a P4 CPU.

### DETAILED DESCRIPTION OF THE PREFERRED EMBODIMENT

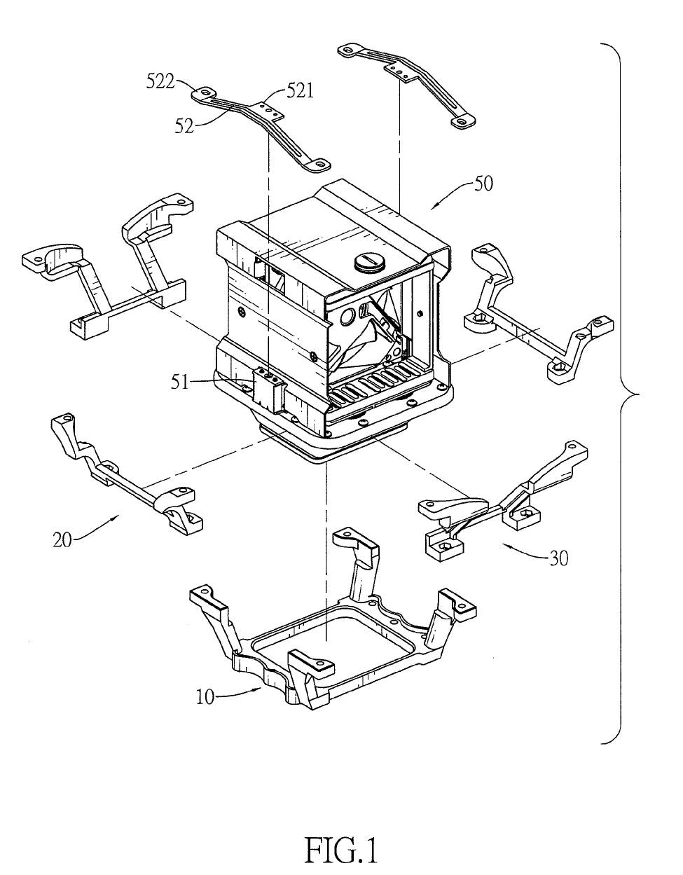

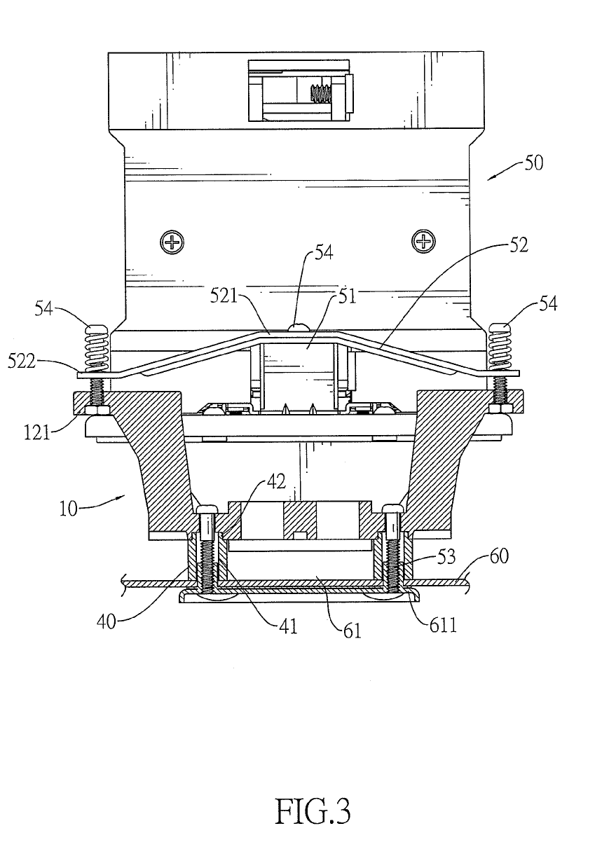

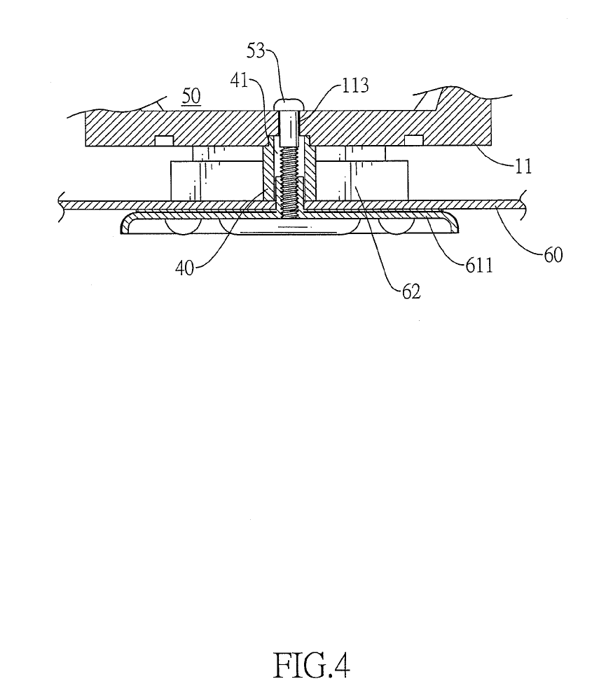

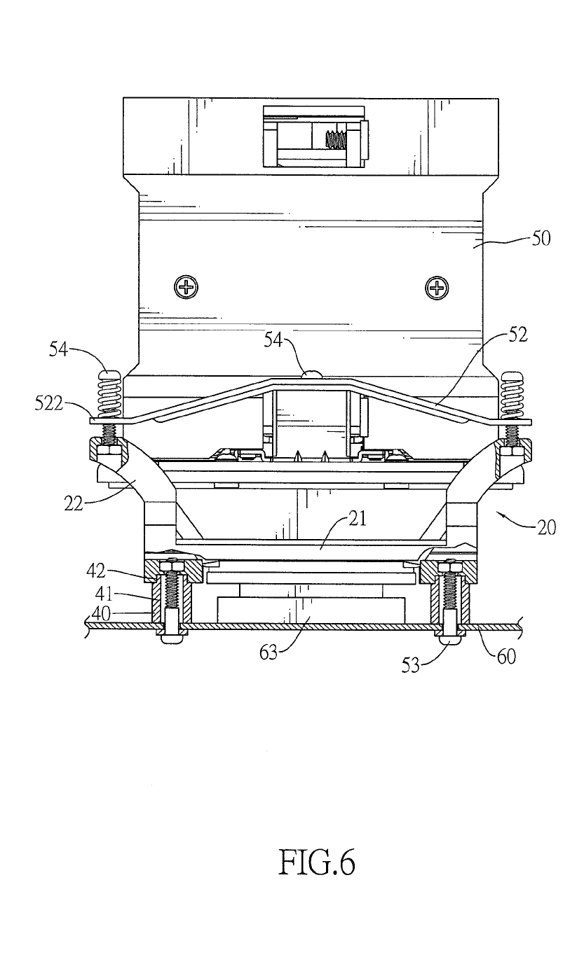

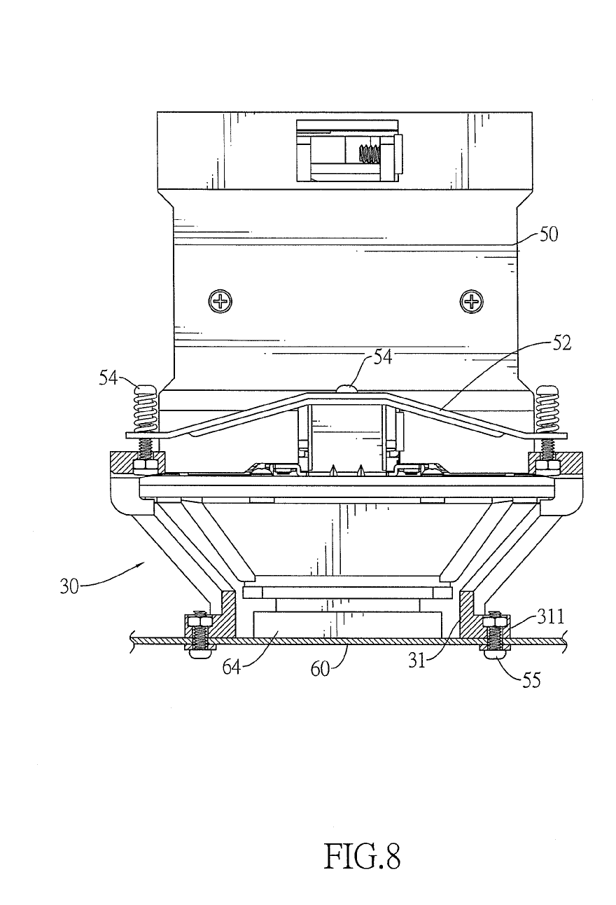

With reference to FIGS. 1, 3, 4, 6 and 8, a heat dissipator fastener kit in accordance with the present invention provides multiple elements to configure specific heat dissipator fasteners in accordance with the present invention, which can attach a conventional heat dissipator (50) to a motherboard (60) and accommodate numerous different CPUs (61, 62, 63, 64).

The conventional heat dissipator (50) abuts a CPU (61, 62, 63, 64), dissipates heat generated by the CPU (61, 62, 63, 64) and typically comprises multiple fins (not shown), multiple tubes (not shown), four bottom edges, two sides and two shoulders (51). The fins and the tubes are mounted inside the heat dissipator (50). The shoulders (51) are formed respectively on the sides, and each shoulder (51) has at least one mounting hole.

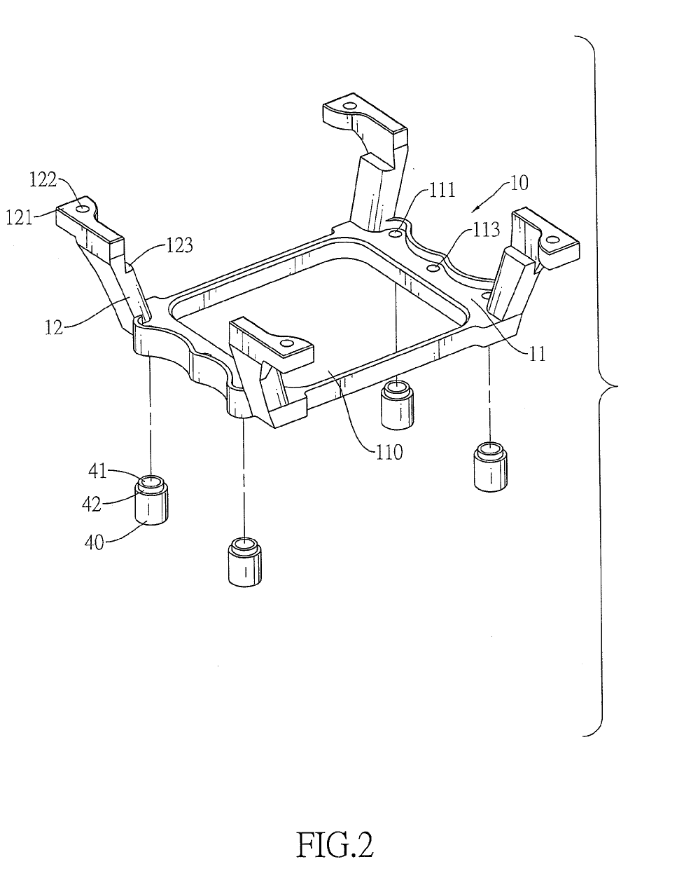

With further reference to FIG. 2, the heat dissipator fastener kit comprises at least two retaining bars (52), at least one bracket (10, 20, 30), multiple fasteners (53, 54, 55) and multiple optional spacers (40).

The retaining bars (52) are resilient and bent down slightly and are attached respectively to shoulders (51) on the sides of a heat dissipator (50), and each retaining bar (52) has two end tabs (522), a middle tab (521), two through holes and at least one mounting hole. The through holes are formed respectively in the end tabs (522). The at least one mounting hole is formed through the middle tab (521) and corresponds respectively to the at least one mounting hole in the corresponding shoulder (51) of the heat dissipator (50).

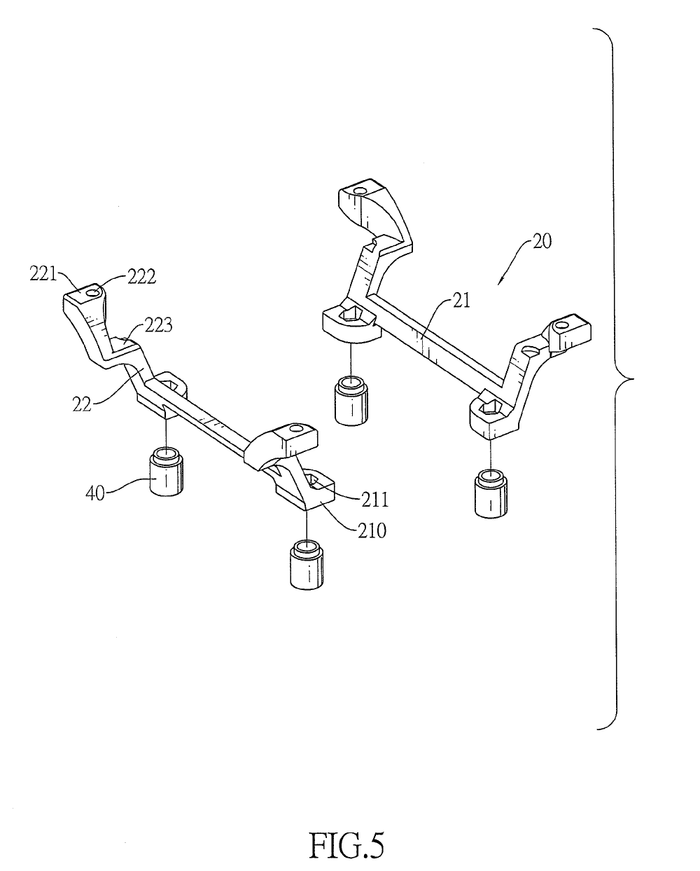

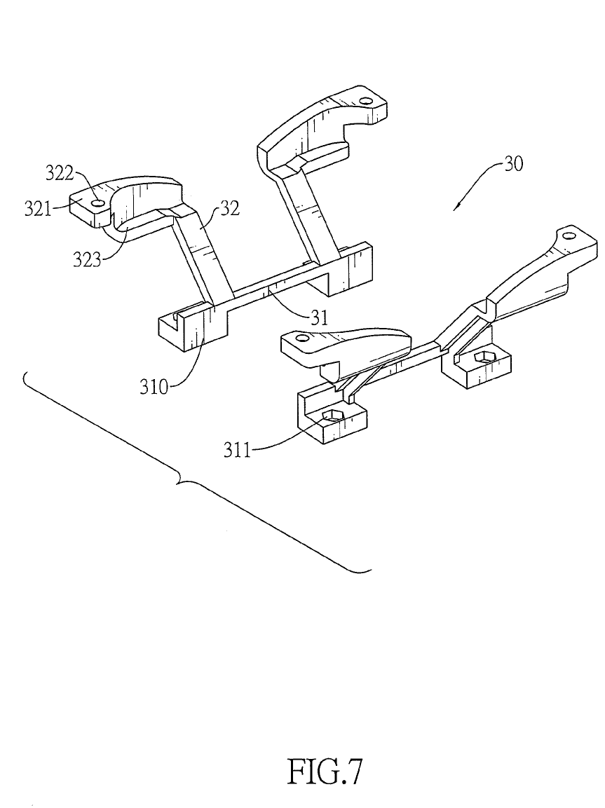

With further reference to FIGS. 5 and 7, the bracket (10, 20, 30) attaches to a motherboard (60) around a CPU (61, 62, 63, 64) and to the retaining bars (52), aligns a heat dissipator (50) with the CPU (61, 62, 63, 64), holds the heat dissipator (50) securely against the CPU (61, 62, 63, 64), may be a one-piece bracket (10) or a two-piece bracket (20, 30) and comprises at least one base (11, 21, 31) and four posts (12, 22, 32).

The one-piece bracket (10) attaches to a motherboard (60) and mounts a heat dissipator (50) on an AM2 CPU (61) and a K8 CPU (62).

The two-piece first and second bracket (20, 30) may be a first bracket (20) and a second bracket (30). The first bracket (20) attaches to a motherboard (60) and mounts a heat dissipator (50) on an LGA775 CPU. The second bracket (30) attaches to a motherboard (60) and mounts a heat dissipator (50) on a P4 CPU.

Each base (11, 21, 31) has a bottom surface and multiple outer mounting holes (111, 211, 311). The base (11) of the one-piece bracket (10) is square and further has two sides, four corners, two inner mounting holes (113) and a central hole (110). The central hole (110) unmasks a CPU (61, 62) around which the base (11) is mounted. A two-piece first and second bracket (20, 30) has two bases (21, 31), and each base (21, 31) further has a top surface, an inner surface, an outer surface, two ends and two feet (210, 310). In the base (21) of the first bracket (20), the feet (210) are formed on the bottom surface and inside surface respectively at the ends of the base (21) and protrude in from the inside surface. In the base (31) of the second bracket (30), the feet (310) are formed on the bottom surface and outside surface respectively at the ends of the base (21) and protrude out from the outer surface. Each outer mounting hole (111, 211, 311) has an upper end, a lower end, an optional nut recess and an optional spacer recess. The nut recess is formed coaxially in the upper end of the outer mounting hole (111, 211, 311). The spacer recess is formed coaxially in the lower end of the outer mounting hole (111, 211, 311). In the one-piece bracket (10), the outer mounting holes (111) are formed through the base (21) adjacent to a side and respectively near the corners. In the two-piece first and second brackets (20, 30), the outer mounting holes (211, 311) are formed respectively through the feet (210, 310) of the bases (21, 31). In the one-piece bracket (10), the inner mounting holes (113) are formed respectively on opposite sides of the base (11) between adjacent outer mounting holes (111), and each inner mounting hole (113) has an upper end, a lower end, an optional nut recess and an optional spacer recess. The nut recess is formed coaxially in the upper end of the inner mounting hole (113). The spacer recess is formed coaxially in the lower end of the inner mounting hole (113).

The posts (12, 22, 32) are formed on and protrude up and slightly out from the top surface of the base (11, 21, 31), and each post (12, 22, 32) has a top end, an inner side, a holding arm (121, 221, 321) and a receiving notch (123, 223, 323). In the one-piece bracket (10), the posts (12) are formed respectively at the corners of the base (11). In the two-piece first and second brackets (20, 30), the posts (22, 32) are formed respectively at ends of each base (21, 31). The holding arm (121, 221, 321) is formed horizontally on and protrudes out from the top end of the post (12, 22, 32) and has a distal end, an inner side and a securing hole (122, 222, 322). The distal end has a bottom notch. The securing hole (122, 222, 322) is formed through the holding arm (121, 221, 321) near the distal end and communicates with the bottom notch. Securing holes (122, 222, 322) respectively in adjacent holding arms (121, 221, 321) correspond to the through holes in the corresponding retaining bar (52). The receiving notches (123) are formed respectively on the inner sides of the posts (12, 22, 32) and the holding arms (121, 221, 321) at the top of the posts (12, 22, 32) and hold bottom edges of a heat dissipator (50) and position the heat dissipator (50) securely against the corresponding CPU (61, 62, 63, 64).

The fasteners (53, 54, 55) include motherboard fasteners (53, 55) and retaining bar fasteners (54), may be bolts and may attach to a nut or a threaded hole. The motherboard fasteners (53, 55) extend respectively through the mounting holes (11, 211, 311, 113) in the base (11, 21, 31) of the bracket (10, 20, 30) and holes in a motherboard (60), attach to a motherboard (60) to connect the bracket (10, 20, 30) to the motherboard (60) and may screw into nuts or a motherboard retaining plate (611). The retaining bar fasteners (54) connect the retaining bars (52) respectively to shoulders (51) of a heat dissipator (50) and to a bracket (10, 20, 30). The retaining bar fasteners (54) that connect the retaining bars (52) respectively to shoulders (51) on the heat dissipator (50) extend respectively through the mounting holes in the middle tab (521) of the retaining bar (52) and screw into the shoulder (51). The bar fasteners (54) connecting the resilient bars (52) to the bracket (10, 20, 30) extend respectively through the through holes in the end tabs (522) of the retaining bar (52) and the securing holes (122, 222, 322) in the holding arms (121, 221, 331) of the posts (12, 22, 32), may screw respectively into nuts mounted below the holding arms (121, 221, 331) and may have resilient elements through which the bar fasteners (54) respectively pass to make an attached heat dissipator (50) self-aligning.

The spacers (40) are cylindrical and hollow and are mounted respectively around motherboard fasteners (53) between the bracket (10, 20, 30) and the motherboard (60) to provide adequate separation between the bracket (10, 20, 30) and the corresponding CPU (61, 62, 63, 64), and each spacer (40) has bottom end, a top end, a neck (42) and a through hole (41). The neck (42) is formed at the top end and is mounted in a spacer recess around a mounting hole (111, 211, 311, 113) to hold the spacer (40) in position. The through hole (41) is formed longitudinally through the spacer (40) and allows the motherboard fastener (53) to pass through the spacer (40).

Accordingly, the heat dissipator fastener kit accommodates many types of motherboards (60) to securely fasten a heat dissipator (50) onto a CPU (61, 62, 63, 64) mounted on the motherboard (60).

Users may conveniently select one of the brackets from the fastener kit based on the type of motherboard (60) and attach the bracket to the motherboard (60) to securely hold a heat dissipator (50). With such an arrangement, the heat dissipator fastener kit is convenient and easy to use.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A heat dissipator fastener kit comprising
at least three different brackets having several embodiments to accommodate different types of CPUs and specific mother boards; and
multiple fasteners attaching the bracket to a motherboard; and
multiple spacers being mounted respectively around motherboard fasteners between the bracket and the motherboard to provide adequate separation between the bracket and the corresponding motherboard.

2. The heat dissipator fastener kit as claimed in claim 1, wherein the at least three brackets include a one-piece bracket having
a base being square and having
two sides;
four corners;
a central hole;
four outer mounting holes being formed through the base adjacent to a side and respectively near the corners; and
four posts being formed respectively at corners of the base, and each post having
a top end,
an inner side,
a holding arm being formed horizontally on and protruding out from the top end of the post and having
a distal end having a bottom notch,
an inner side and
a securing hole being formed through the holding arm near the distal end and communicating with the bottom notch; and
a receiving notch being formed on the inner side of the post and the holding arm at the top of the post.

3. The heat dissipator fastener kit as claimed in claim 2, wherein the one-piece bracket further has two inner mounting holes being formed respectively on opposite sides between adjacent outer mounting holes.

4. The heat dissipator fastener kit as claimed in claim 1, wherein the at least three brackets include a two-piece first bracket having
two bases, each base having
a top surface;
an inner surface;
an outer surface;
two ends; and
two feet;
four outer mounting holes being formed respectively through the feet; and
four posts being formed on and protruding up and being formed respectively at ends of each base, and each post having
a top end,
an inner side,
a holding arm being formed horizontally on and protruding out from the top end of the post and having
a distal end having a bottom notch;
an inner side; and
a securing hole being formed through the holding arm near the distal end and communicating with the bottom notch; and
a receiving notch being formed on the inner side of the post and the holding arm at the top of the post.

5. The heat dissipator fastener kit as claimed in claim 2, wherein
each outer mounting hole further has a lower end and a spacer recess being formed coaxially in the lower end of the outer mounting hole; and
each spacer has
a bottom end;
a top end;
a neck formed at the top end and mounted in a spacer recess around a mounting hole to hold the spacer in position; and
a through hole formed longitudinally through the spacer and allowing a corresponding fastener to pass through.

6. The heat dissipator fastener kit as claimed in claim 4, wherein
each outer mounting hole further has a lower end and a spacer recess being formed coaxially in the lower end of the outer mounting hole; and
each spacer has
a bottom end;
a top end;
a neck formed at the top end and mounted in a spacer recess around a mounting hole to hold the spacer in position; and
a through hole formed longitudinally through the spacer and allowing a corresponding fastener to pass through.

7. The heat dissipator fastener kit as claimed in claim 1, wherein the at least three brackets include a two-piece second bracket and having
two bases, each base having
a top surface;
an inner surface;
an outer surface;
two ends; and
two feet;
four outer mounting holes being formed respectively through the feet; and
four posts being formed on and protruding up and being formed respectively at ends of each base, and each post having
a top end;
an inner side;
a holding arm being formed horizontally on and protruding out from the top end of the post and having
a distal end having a bottom notch;
an inner side; and
a securing hole being formed through the holding arm near the distal end and communicating with the bottom notch; and
a receiving notch being formed on the inner side of the post and the holding arm at the top of the post.

8. The heat dissipator fastener kit as claimed in claim 4, wherein each mounting hole in the one-piece bracket has a spacer recess formed coaxially in the lower end of the mounting hole.

9. The heat dissipator fastening assembly fastener kit as claimed in claim 5, wherein the fasteners are attached respectively to nuts.

10. The heat dissipator fastener kit as claimed in claim 9, wherein a nut recess is formed coaxially in the upper end of each mounting hole.
